(19) United States
(12) Patent Application Publication
(10) Pub. No.: US 2008/0097888 A1
(43) Pub. Date: Apr. 24, 2008

(54) Method for Managing Markets for Commodities Using Fractional Forward Derivative

(76) Inventor: George Sugihara, Del Mar, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/576,815

(22) PCT Filed: Oct. 7, 2005
(86) PCT No.: PCT/US05/36204

§ 371 Date: Apr. 5, 2007

Related U.S. Application Data
(60) Provisional application No. 60/617,371, filed on Oct. 8, 2004.

(51) Int. Cl. G06Q 40/00; G06Q 10/00

(52) U.S. Cl. 705/37

(57) ABSTRACT

A fractional forward contract provides a financial instrument for managing trading of commodities that have variable and unpredictable availability at future dates by apportioning risk between parties (100, 170) by providing for parties (100, 170) to buy and sell a specified fraction of a commodity that the supplier (100) has in his inventory on a specific date, rather than a specified quantity. Trading is managed by a trading exchange or clearinghouse (130) via a computer network (120). The fractional forward contract provides a method for managing a market for a perishable commodity harvested from the wild by establishing a total allowable quantity of the perishable commodity that can be harvested over a pre-determined time period, permitting the harvester to contract for sale of some fraction of the actual harvest at a guaranteed price at a future date.

### RELATED APPLICATIONS

This application claims the benefit of priority of U.S. Provisional Application Ser. No. 60/617,371, filed Oct. 8, 2004, which is incorporated herein by reference.

### FIELD OF THE INVENTION

The present invention relates to a system and method for apportioning risk and reward between parties contracting to buy and sell a commodity at a future date.

### BACKGROUND OF THE INVENTION

Businesses often need to know their future costs to permit accurate budgeting and to manage their cash efficiently. Commodity futures markets, for example, arose from the need of farmers and of their customers to lock in the price that would be paid for a farm commodity when it was actually harvested, and to provide the farmers with operating capital in advance of the harvest. In essence, such futures markets transferred price risk from those who wished to avoid it to those willing to accept it in the hopes of gaining a reward for doing so. Futures contracts now exist not only for agricultural products such as corn and wheat, but for livestock, petroleum products, and precious metals, among others. Similar desires to transfer risk from those exposed to it to those willing to accept it led to development of forward contracts (in which a contract is made at one time for delivery of the commodity later) and options.

Prices in general result from the interplay of supply and demand, but for some goods most of the variation in price results from variation in supply, with demand being relatively constant. Suppliers in such cases face a serious problem: a forward contract may oblige them at the settling date to provide more of the goods than they will actually have available.

Recognition of such a shortfall as the settling date approaches forces suppliers either to unwind part of their original forward position by either buying the commodity on the spot market to satisfy the contract or by entering into a second forward contract (this time as a purchaser, rather than a supplier, of the commodity) that offsets the anticipated shortfall. Since shortfalls in commodities commonly arise from factors that affect all suppliers, e.g., weather unwinding forward positions near the settling date can require suppliers to bid against each other for what unexpectedly has become a scarce commodity, driving up the price, much like a short squeeze in the stock market.

In some industries, shortfalls in the underlying commodity have an especially pernicious effect. In commercial fishing, for example, shortfalls motivate fishermen to try to catch still more fish from what is often an already depleted fishery, thereby exacerbating the original shortfall and jeopardizing future catches as well through a “tragedy of the commons” effect.

Methods have been disclosed for managing and trading in commodity markets for renewable resources (fibers, grains and feed, livestock and meat, lumber, etc.) and for commodities harvested from real property (metals, fuels, etc.). A new market has recently arisen for trading of pollution credits as described in U.S. Pat. No. 6,601,033, which is incorporated herein by reference. However, to date, there have been no methods disclosed for managing and trading in perishable commodities that are derived from natural resources.

Commodities are typically traded on exchanges such at the Chicago Board of Trade (CBT) or the New York Mercantile Exchange (NYMEX), as well as several other exchanges using financial instruments such as futures, forwards, swaps, and options. The trading of futures are regulated by the Commodity Futures Trading Commission (CFTC). Methods for managing and trading financial instruments have been described in a number of issued patents. A method for trading interest rate swaps is described in U.S. Pat. No. 6,304,858. A method for trading contracts to limit risk is described in U.S. Pat. No. 6,912,510 and U.S. Pat. No. 6,134,536, and a method for trading contingent claims is described in U.S. Pat. No. 6,321,212, each of the listed patents are is incorporated herein by reference. The automated trading of futures is described in U.S. Pat. No. 4,903,201, incorporated herein by reference. Also, a method to manage investments in a mutual fund is described in U.S. Pat. No. 6,338,047, incorporated herein by reference.

Futures, forwards, and options are classes of derivatives. A derivative is financial instrument (a contract) whose value is derived from the price of an asset called the “underlying”. The underlying need not always be a tradable product (e.g. equities, currencies, commodities, rainfall, etc.); a derivative may also be used for hedging and speculation. Derivatives, futures, forwards, options, and underlyings are standard terms in the financial industry.

A commodity future is a contract in which there is an agreement between a buyer and seller to buy or sell a specific quantity of a commodity at a set price on or by a specified date in the future. Forwards are similar to futures except that they are not traded on an exchange, but are a contract between private parties, often referred to as over the counter (OTC) trading, and are for a quantity of a commodity at a set price to be completed on or by a specified date in the future. Commodity options are contracts that give the holder the right to buy or sell a commodity at a fixed price by some date in the future. The option is good for a limited time, and if it is not exercised by that date, it expires. With the American version, the option contract can be settled anytime, up to and including the specified date in the future, but with the European version, the option contract can only be settled at the specified date in the future.

An advantage of trading futures in an exchange is that the trading is fully regulated, so the that risk of the manipulation of the market is kept under check. The exchange provides easy access for purchasing and selling of futures. Buyers need not search for sellers and sellers need not search for buyers—the exchange provides the forum for trading. Financial risks can be mitigated by well known hedging methods. In contrast, with forwards, individual parties must seek out one another to make their deals. Unlike futures, there is no administrative regulation of forwards.

One perishable commodity taken from the wild, fish or seafood, is typically not traded using futures on an exchange, but are traded OTC using forwards. Sixty percent of the seafood commodity includes shrimp, salmon and trout, tuna, groundfish (bottom feeders), crab and lobster, and cephalopods such as squid. A few exceptions have occurred, including black and tiger shrimp, which were traded on the Minnesota Grain Exchange from 1991 to 2002. At the Kansai Commodities Exchange in Osaka, Japan, a 54 Kg lot contract for frozen, headless black tiger shrimp was offered. For the most part, fisheries are not traded on an exchange.

According to a report by the Food and Agriculture Organization of the United Nations' (FAO) (“The State of World Fisheries and Aquaculture (SOFIA) 2002”), for the fiscal year 2000, 94.8 million tonnes were landed globally for a first-sale value of 81 billion dollars. Fishing is one of the riskiest and most variable occupations in the world. Fish prices are volatile and such volatility creates risk, both in terms of human safety and financial uncertainty. Current pricing for fish and other perishable commodities harvested from the wild is fragmented with no mechanism for price feedback from future expectations. There are no standard market mechanisms or hedging instruments to reduce financial risks or for increasing the efficiency of transactions with the fishery commodity. Fisheries are the only major commodities without hedging instruments for reducing this risk and are unique among the world's commodities in this regard. Also, most fishery markets are fragmented and inefficient and it is difficult to obtain consensus on how to manage fisheries, consequently, they tend to be poorly regulated. The FAO has reported that “an increasing number of fisheries are either fully exploited or overexploited” and many commercial fish populations are thought to be either fully exploited or in serious decline. According to Myers and Worm (Nature, Vol. 423, pp. 280-283, May 15, 2003), the world's oceans have lost over 90% of large predatory fish compared to the pre-1970's levels.

Only when the population of a specific species of fish is dangerously low does the government step in to regulate parts of the fishery market. This has already happened with several species in the past and the present. The United States federal government has regulated the quantity or the total allowable catch (TAC) of a fishery that may be harvested by creating and implementing the individual fishing quotas (IFQ). The TAC is set by a scientific advisory board based on input for stakeholders, current landings, and biophysical forecasts. The IFQ is a federal permit that is held by an individual, permitting him or her to harvest a percentage of the TAC for a specific fishery. The IFQ has been implemented in four U.S. fisheries: Alaskan halibut and sablefish, wreckfish, surf clams and ocean quahogs.

The U.S. Congress passed the Magnuson-Stevens Fishery Conservation and Management Act in 1976 creating the vessel moratorium program under the limited entry system. This program severely limited fishing of certain species. In 1990, the individual transferable quota (ITQ) system was implemented. Under the ITQ system, ITQ shares (similar to the IFQ), may be traded or leased to any person or entity. While the ITQ system is a significant improvement over the previous system, the system works on an OTC basis and there is no centralized location, i.e., an exchange, for the trading of the ITQs.

The ITQ can be viewed as a form of an underlying, and the ITQ provides property rights, i.e., a percent share of the TAC. The ITQ promotes sustainability of fishery through ownership and eliminates the “rush to fish” of derby-style fishing, where the catch is limited only to what can be brought in over a specified time period and safety precautions are abandoned in order to maximize profits. It also eliminates the incentives for over-capitalization while increasing the value of the fishery and provides incentives for self-policing. The ITQ provides a means to trade ownership so that those who have the motivation and efficient means to harvest the resource can do so. The ITQ leads to better stock assessments resulting in appropriate regulations setting the TAC limits which are based upon better scientific management advice from more accurate scientific information. The ITQ is based on controlling and monitoring the outputs rather than the usual approach of controlling inputs.

An example of the effectiveness of the ITQ type system is the Alaskan Halibut. The International Pacific Halibut Commission was established in 1923 by an agreement between Canada and the U.S. Over the period of 1976 to 1992, a series of limited access measures were applied by the North Pacific Halibut Commission to help manage diminishing stock levels. Rumors of a moratorium in the 1980's lead to overcapitalization. By the early 1990's, the fishing season for halibut was reduced from over 290 days to as few as two 24-hour periods. In 1995, IFQs were implemented by the National Marine Fishery Service (NMFS). Since then, fish stocks appear to be in good shape and well managed. The fishery has higher revenues as a result of higher quality of fish and higher quality product to the market place. Safety and vessel efficiency has also increased.

Even with the success of the Alaskan fishery, there is a widespread distrust of a quota system. The need remains for a fair means for the initial allocation of the ITQ and an accessible market place for trading in ITQs. ITQs should be liquid and transparent. The need exists for a new exchange that can address and achieve each of these goals by apportioning risk between buyers and sellers of commodities to mitigate the deleterious economic, and often environmental, effects of variations in supply of commodities.

### SUMMARY OF THE INVENTION

It is an advantage of the present invention to provide a method for creating and maintaining an orderly market in a perishable commodity harvested from the wild that is renewable, in uncertain supply, and prone to over-exploitation.

Another advantage of the present invention is to provide a method for mediating and recording current- and advance-sales transactions for a perishable commodity harvested from the wild.

It is another advantage of the invention to provide a method that employs a novel derivatives contract to overcome liquidity constraints and promote resource sustainability.

Yet another advantage of the present invention is to provide a method for building an orderly market when liquidity concerns loom large—for managing risk and reducing price volatility in illiquid markets.

The Perishable Resource Exchange (PRX) of the present invention addresses such a need by combining the derivatives in the fishery market with individual fishing quotas. The inventive method introduces a new type of forward contract, a fractional forward contract (FFC), to be used as the predominate exchange tool under the PRX in order for the efficient management of our limited ocean's resources. The FFC differs from the forward contract in that the FFC is based on a percentage of a fisherman's catch and is not specified in terms of an absolute quantity.

A fractional forward contract for conducting trading of a commodity supplied by a supplier having an inventory of the commodity and a buyer of the commodity comprises an agreement that specifies a commodity, a unit of the commodity, such as a measure of weight, volume, or number, and an upper bound of the supplier's inventory, specified in the unit. It further specifies a fraction of the supplier's inventory, expressed in the unit, a contract period over which the supplier's inventory will be determined, a settling date, and a price per unit at which, on the settling date, the supplier will sell the fraction of the inventory.

The invention provides a method for building an organized market for perishable commodities such as fisheries, and for wildstock in general. The PRX (Perishable Resource Exchange) addresses inadequacies of existing methods because it addresses a problem unique to a perishable resource, such as fish and seafood, harvested from the wild: that of establishing supply and demand, with marine conservation in mind, in such a way that does not exhaust the resource or create short-term scarcity introduced by limiting the harvest period to a less-than-reasonable time given the period of perishability. The inventive method also provides for feedback on future pricing that is currently unavailable to the often fragmented fishery market.

The derivatives market can provide greater price stability and lower financial risk, i.e., insurance, to both fishers and processors. Derivative contracts can be designed to promote resource/industry sustainability. According to the present invention, Fractional Forward Contracts (FFCs) have the desirable feature of providing less incentive to fish intensively during periods of resource scarcity. There is an incentive to not fish if the resource becomes scarce so the unit harvest costs exceeds the minimal target price of the FCC. For example, the FFC is an ideal mechanism for the trading of squid. Such a program should be particularly easy to implement since squid is a relatively new fishery, with a “blank slate”, i.e., less historical inertia and established factionalism compared to other fisheries. Further, it will be more readily accepted by more sophisticated stakeholders. The value of the squid market is high, with the global cephalopod export market having an annual export value of US $2.4-2.8 billion, and is one of the fastest growing fisheries. The market for the squid fishery has become one of the largest in California with ex-vessel revenue in 2000 of about $36 million, and there is further opportunity to improve its value. The FFC should reduce the price and landings volatility. Over the past decade, ex-vessel prices for the California squid market have been very volatile, ranging from $0.06 to $0.39 per pound annually. Over this same period, the catch volatility ranged from 3,000 tons to over 120,000 tons. In addition to addressing these large swings in price and catch volume, the FFC would enhance conservation. On a global scale, squid are relatively abundant and appear to have highly opportunistic reproduction that allows them to recover from environmental bottlenecks at a remarkable rate.

Hedging in derivatives markets can reduce price volatility, risk and uncertainty. Hedging is desirable for both fishermen and processors. Hedging relies on the concepts of “insurance” and “risk management”, which are ideas that can be easily embraced. Speculation in derivatives markets that promotes outside participation will necessarily bring more revenue into the marketplace that will flow to those with the best information—the stakeholders. It can also allow stakeholders to increase risk if they so desire.

Market forces and economic concerns embody values shared by all cultures and resonate with human behavior. Market forces have an incentive dynamic that may be self-propagating and self-policing but should be organized and harnessed for furthering conservation goals and not held out as antithetical to conservation. Organized markets provide an institutional infrastructure with clout, encourage efficiency, and provide an opportunity for efficient regulation that can promote sustainability. Sustainability is desirable to anyone with a capital investment.

Conservation goals can be explicitly built into the contracts that PRX administers giving rise to “green”, i.e., environmentally friendly, contracts which may be useful for public marketing of fish traded through the PRX. For example, the FFC can include a provision that aims to keep the catch at some scientifically determined TAC level or keep the spawning stock above some low-risk escapement level.

It is anticipated that the PRX will create a new industry in the form of an organized financial marketplace that provides new opportunities for efficiently transacting for the fishery business and further provides a transparent and orderly market place for trading and leasing ITQs and derivatives. The PRX also provides a forum for conveniently setting prices on the underlying commodities. In a preferred embodiment, the PRX will partner with the CCX and use the electronic trading platform that is now in place at CCX. The expertise provided by CCX will make PRX unique among current quota systems.

### BRIEF DESCRIPTION OF THE DRAWINGS

The present invention will be more clearly understood from the following detailed description of the preferred embodiments of the invention and from the attached drawings, in which:

FIG. 1 is a block diagram showing an overview of an exemplary computer-implemented system for establishing fractional forward contracts of the present invention.

FIG. 2 depicts the fields of an exemplary website offering page.

FIG. 3 shows the fields of an exemplary contract database entry.

### DESCRIPTION OF THE PREFERRED EMBODIMENTS

The following detailed description utilizes a number of acronyms, most of which are generally well known in the art. While definitions are typically provided with at least the first instance of each acronym, for convenience, Table 1 below provides a list of commonly known acronyms and invention-specific abbreviations and their respective definitions.

TABLE 1

| Acronym | Definition |
|---|---|
| CCX | Chicago Climate Exchange |
| CFTC | Commodity Futures Trading Commission |
| FAO | Food and Agriculture Organization (U.N.) |
| FFC | Fractional Forward Contract |
| IFQ | Individual Fishing Quota |
| ITQ | Individual Transferable Quota |
| NMFS | National Marine Fishery Service |
| PRX | Perishable Resource Exchange |
| OTC | Over-the-Counter |
| SEC | Securities and Exchange Commission |
| TAC | Total Allowable Catch |

A supplier of a commodity wishing to offer a fractional forward contract (FFC) for transfer of the commodity specifies terms including the identity of the commodity, a unit by which the commodity will be measured, such as a measure of weight, volume, or number, and an upper bound of the supplier's inventory, i.e., the maximum quantity, expressed in the unit, that the supplier is willing to offer in the contract.

The supplier further specifies what fraction of his inventory, expressed in the unit, he wishes to offer in the contract, and a contract period over which the supplier's inventory will be determined. The fraction may be expressed as a percentage, or as a quotient, such as one-quarter, but in either case will be dimensionless. For example, the supplier may offer one-quarter of his inventory by weight, by volume, or by quantity, for items amenable to enumeration, depending on the nature of the commodity.

The supplier also specifies a contract period, which is the time over which his inventory will be assessed for the purposes of the contract. For example, a fisherman offering a FFC on the fish he catches over a two week fishing expedition, rather than the fish in his inventory on a given day, could specify a given two week period as the contract period.

The supplier further specifies a settling date, on which the trade will be consummated, and a price per unit at which, on the settling date, the supplier will sell the fraction of the inventory. In one embodiment, the supplier also sets the price the purchaser must pay to enter into the contract.

A purchaser accepting the supplier's offered FFC provides the supplier with the agreed-upon consideration, if any. In a preferred embodiment, the purchaser would purchase the FFC with cash or other financial instrument, but payment could also be made in kind. The supplier reports his inventory over the contract period, determines the appropriate fraction of the inventory, as agreed in the FFC, and on the settling date, sells that fraction to the purchaser at the agreed-upon price per unit.

The present invention comprises creating and maintaining an efficient market through offering fractional forward derivative instruments related to the allowable fraction of the harvest, rather than an absolute quantity. For example, if the commodity is squid harvested from the ocean, the market would be established to allow the buying and selling of FFCs related to a fraction of the catch during some time period, for example a month. This would allow external regulators to continue to set catch limits or harvest periods, but with a pricing mechanism in place to provide more efficient feedback to the harvesters for particular harvest periods.

In the preferred embodiment of the present invention that is applicable to fisheries, the FFC is the central financial instrument used by the PRX and should only be traded on the PRX to allow proper regulation of the fishery. The FFC is bought and sold via the PRX, in the same manner that other commodities are bought and sold in the futures market. The quantity of FFCs are reported by the PRX in some form of public media such as a journal, newspaper, on-line over the World Wide Web, or by any other means that provides communication to and access by the public. A seller, typically a fish or seafood harvester, but also possibly a speculator or hedger, offers his or her FFCs to buyers via the PRX. A buyer, typically a producer, but also possibly a speculator or hedger, places a bid via the PRX for a FFC. The PRX system matches up the bids from both buyers and sellers, similar to the futures markets, and finalizes the transactions.

More generally, the FFCs may be traded through a clearinghouse or other type of exchange forum that provides similar services to those described relative to the PRX.

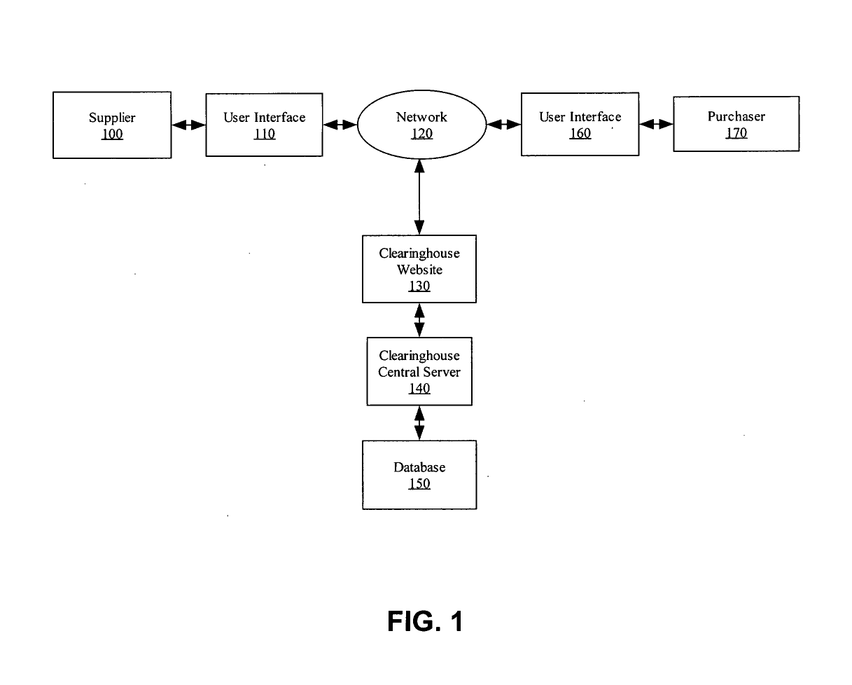

In a preferred embodiment, fractional forward contracts are offered and transacted by way of a computer network. One or more suppliers transmit proposed terms of offered fractional forward contracts to a central server, which maintains a database of fractional forward contracts on offer. Referring to FIG. 1, supplier 100 uses a conventional network user interface 110 to access an exchange or clearinghouse website 130 where supplier 100 enters proposed terms for a fractional forward contract. The information entered is transmitted from website 130 to clearinghouse central server 140, which records the information in database 150. Server 140 transmits information from database 150 to website 130 for communicating information via Internet 120 to a conventional user interface 160 for viewing by purchaser 170.

Website 130 provides access to a listing of proposed terms of the offered fractional forward contracts such as the commodity, the unit in which the commodity is measured, the price per unit, the maximum inventory possible, the fraction of inventory being offered for sale, and the settling date or date range pertaining to the fraction of inventory offered.

Purchaser 170 uses interface 160 to enter his or her purchase order, which is then transmitted via network 120 to the central server 140 via website 130. Central server 140 receives the purchaser's transaction information, verifies the purchaser's identity and financial bona fides, then updates database 150 and website 130 to reflect the purchaser's transaction. The central server then optionally sends a communication to supplier 100 to indicate acceptance by purchaser 170 of the offered fractional forward contract.

In a preferred embodiment, communications taking place over the Internet or other network are appropriately encrypted for security using techniques used in other financial transactions.

### Example 1

Exchanges involving ITQs and FFCs: The FFC is bought and sold in standard quantity units. Each standard quantity unit is an equal fractional percentage of the fisherman's ITQ. The equal fractional percentage is created by dividing a percentage of the fisherman's ITQ for a specific time period for a particular fishery by the number of fractional forward contracts allocated to the fisherman. For example, if a fisherman is allocated 100 FFCs, then the standard unit is 1% and one FFC will be for 1% of a fisherman's harvest of a particular fishery, up to the maximum of 1% of the fisherman's ITQ. In other words, there are one hundred—1% FFC individual contracts for the particular fishery for a specific fisherman for a specific time period. If the FFC is for 0.5% of the fisherman's harvest, then there will be two hundred—0.5% FFC individual contracts, or if the FFC is for 10% of the fisherman's harvest, then there will be ten—10% FFC individual contracts, and so on. The fisherman's harvest limit is dictated by his ITQ. The ITQ limit is set by the government regulatory agency as a percentage of the TAC that is based upon scientific estimations of the fishery's population. This information is maintained by the PRX and should be made available for viewing by the general public.

The FFC mimics many of the requirements of the ITQ and contains the following terms: it identifies what fishery the contract is for; what region may be fished, and the unit price per quantity. The FFC also sets the maximum quantity or a percentage of the ITQ, the percentage of the harvest or standard unit, the date or date range when the harvest is due; and where the harvest is to be delivered. The FFC is a contract with all of the terms of the contract being specified except for the absolute quantity term, which is instead specified as a percentage of the actual harvest. All of the terms of the FFC are stored in the PRX database and available for viewing.

In the preferred embodiment, to prevent attempted monopolization of particular market for a commodity, the maximum percentage of TAC ownership that can be accumulated by any one entity (fishermen or producers) will be set by the PRX. For example, no more than 15% of the TAC can be accumulated by any one entity or its affiliates. The maximum percentage of TAC ownership that can be accumulated by any one absentee (speculator) will be set by the PRX. For example, no more than 5% of the TAC can be accumulated by any one absentee.

In the preferred embodiment of the present invention, the FFC is intended to remove the fisherman's concerns over not having deliverable fish at the stated contract delivery time. The FFC is based on a percentage of the fisherman's catch and not on the ITQ absolute quantity. If the fisherman does not fish that season because the limits are so low, the fish population is low, or the weather is severe during the allocated time, the fisherman has no obligation to deliver a harvest since a percentage of zero harvest is zero requirements.

An advantage of the present invention is that the FFC is the only derivative contract that has a negative feedback incentive that inhibits over-exploitation when the resource becomes scarce and when prices for the resource rise. That is, it creates a disincentive to harvest when the resource is scarce and the prices are highest, making them especially useful in the commerce of commodities threatened with declining stocks. Moreover, they remove the sellers' risk of not having deliverable product at the settling date. This makes it especially suited to fisheries where over-exploitation of a common resource is a major concern. For example, during the El Niño years, when the squid population tends to drop drastically, a forward contract can create a severe burden on the fisherman as well as on the fishery. In a normal forward contract, the fisherman would be obliged to deliver a fixed tonnage of squid and the processor would be obliged to pay the contract price at delivery. Because these are legally binding contracts, the unavailability of squid would induce a breach of contract. Moreover, the scarcity of the squid forces the fisherman to use extraordinary measures to increase the catch at a time when the fishery is most fragile. Under the FFC, if a fisherman cannot catch squid, or if it is not economical for him to do so, he or she is not obliged to fish for squid. His or her harvest in the specified time period, e.g., 1 or 2 weeks, may be zero, and 100% of zero harvest is zero. This method will also protect the fishery resource by removing the incentive for over-exploitation at times of low abundance. Thus, when squid are very scarce and the FFC that was entered pays too low a price for the effort and costs required, the fisherman has the incentive to not fish.

In the preferred embodiment of the present invention, for the fisheries that are regulated by the government, the PRX will maintain, i.e., create and update, a database including records of the ITQ for each fisherman and all of the FFCs for each fisherman. The PRX will also maintain records identifying the producers that have FFCs and will maintain all transaction records and all other requirements of the CFTC and the SEC. The PRX provides a centralized location through which the government may issue the ITQ to each fisherman based on the TAC. Each fisherman will be required to register with the PRX in order to receive his ITQ, and processors will also be required to register with the PRX in order to purchase FFCs.

The PRX also provides an ideal marketplace for trading FFCs for fisheries that are not regulated by the government and do not have an ITQ or a TAC. The PRX further provides an ideal marketplace for the trading of underlying assets such as ITQs, Regional Landings Tonnage, Ex-vessel Prices, Processed Fish Prices (e.g., frozen seafood), Export Prices, and Wholesale Prices. Since ITQs are transferable, a fisherman may offer all or any part of his ITQ through the PRX. The ITQs may be bought and sold like other financial instruments.

Trading on the PRX is the method by which FFCs and ITQs are bought and sold by one or more first parties, i.e., sellers (typically fishermen, but perhaps a speculator) and at least one second party, i.e., buyers (typically a producer, but possibly a speculator). The PRX provides the forum through which the buyers and sellers can complete their transactions. The PRX may incorporate any variety of rules, conventions, and facilities for trading. The PRX may provide a trading floor, or it may be exclusively network-based. Individual accounts for buyers and sellers can be established through and maintained by the PRX. The PRX will ensure that an account has sufficient funds for each trade, and settlement requirements will be maintained by the PRX.

The buyer and seller will establish the price for each trade or the price may be established by the PRX. The price for each FFC is listed on the PRX. Provisions may be made for maintaining a confidential price, with only a range of possible prices divulged to the public, since competition among producers may demand such confidentiality. Both indices and enabling contract transactions may be used by the PRX in conjunction with the FFC.

Buyers and sellers can send and receive trade data and other information, such as prices, bids, quotas, information relating to specific ITQs, information relating to specific FFCs, government regulations, TAC for each fishing region, information relating to specific trades, and any other appropriate information.

When a fisherman sells his or her FFC on the PRX, and a purchaser buys the FFC, the quantity of FFCs remaining for that fisherman will be presented on the PRX and the quantity of FFCs purchased will be presented on the PRX. The fisherman's remaining quantity towards his or her ITQ will be also be presented. All of this data will be maintained by the PRX. When the transaction is completed, the PRX will generate a confirming document and forward it to both the buyer and seller with details of the final trade. Preferably, the confirmation will be transmitted electronically, such as by e-mail or via a secure web site.

Another advantage of the present invention is that with the FFCs, the orders can be made far in advance which will help stabilize prices. The market is transparent, with many boats and processors bidding, which helps keep fisherman and processors closer to capacity, and transactions will be done instantaneously in an electronic market place.

Still another advantage of the present invention is that, unlike normal forwards and futures contracts, FFCs do not require high liquidity for success. The present invention provides a method that is suited for emergent markets that lack the liquidity of established markets and that can be used to prime and nucleate a broader derivatives market with speculation instruments.

In the preferred embodiment of the present invention, the PRX is set up to offer a variety of products such as Processed Fish Prices, Export Prices, Catch Quotas, Regulation-Enforced TAC Allocations, FFC Allocations, FFC Details, etc. Other data products that can be offered include Daily Trade and Quote Details, Alerts and Alert Histories, Trading Volume and Summaries, Regulations, Fisherman Lists with Quotas, Producer Lists with Ownership of FFC, Real Time Pricing, Harvest Quantities and Periods, etc.

The PRX provides a significant advantage in limiting the fisherman's risk, thus allowing more fishermen to remain in business. If the fisherman is uncertain about the price a year from now, he or she may sell a limited number of futures contracts to partially offset risk of a precipitous price drop. The value of the futures contract changes continuously (mark-to-market) in tandem with the underlying price of the fish. The fisherman may also purchase a call option to buy at a fixed price if the futures price exceeds some acceptable level (the loss he or she would bear in the futures portfolio). If a year from now, fish prices have fallen, and the price of the future is below what was expected, the fisherman can offset the loss at sea by unwinding his or her short position in futures (buying an amount of futures at the current lower price to cover what was sold a year ago). Thus, the fisherman's losses at sea can be offset by profits in the futures market. If in a year from now the prices have risen, he or she can exercise the call option to cover any losses in the futures market. Again, the fisherman is happy to have some insurance against an unexpected price drop.

In a preferred embodiment of the present invention, the majority of FFCs may only be bought and sold by fishermen and processors. A limited, relatively small number of FFCs may be made available for purchase and sale by speculators. For example, the maximum percentage of FFCs speculators would be allowed to buy and sell would be on the order of 5% of all FFCs available. In another embodiment of the present invention, the maximum percentage of FFCs speculators are allowed to buy and sell may be a maximum of 10% of all FFCs available. In another embodiment of the present invention, the maximum percentage of FFCs speculators are allowed to buy and sell may have a variable value, e.g., x % of all available FFCs, that is set by the PRX based on current market conditions.

While the detailed description and examples deal with fish and seafood, the invention is generally applicable to management of and transactions dealing with commodities derived from cultivated or naturally-occurring resources, e.g., wildstocks and agricultural products. “Wildstocks” includes any commodity that is produced in nature and may be harvested from the wild and is which subject to fluctuations in availability (population) as a result of environmental factors or over-exploitation.

In one embodiment fractional forward contracts are used to trade in foodstuffs, such as agricultural products and seafood, the latter comprising fish, crustaceans, mollusks, and echinoderms. The term “fish” is intended to include pelagic species, groundfish, shallow flatfish, deep water flatfish, forage fish, and cartilaginous fish. Examples of such fish include tuna, salmon, swordfish, cod, mackerel, pollack, rockfish, halibut, flounder, turbot, sole, herring, smelt, shark, skate, and ray. Examples of crustaceans include lobsters, crabs, and shrimp, of mollusks include bivalves, gastropods, and cephalopods, such as clams, mussels, oysters, squid, and octopi.

### Example 2

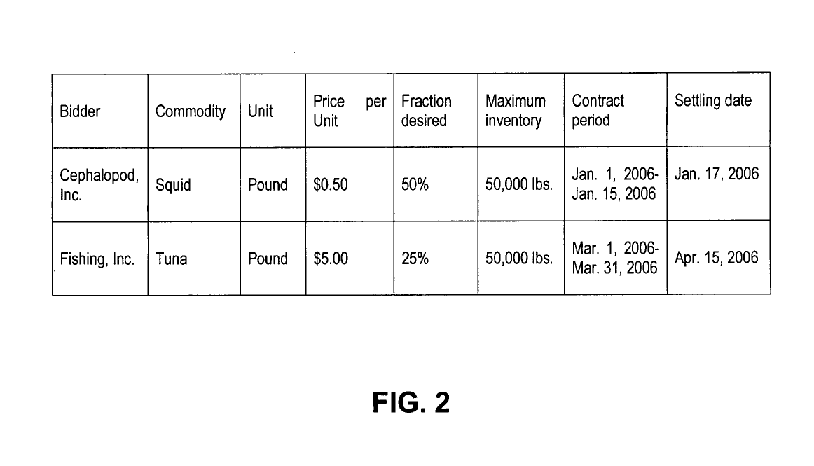

Hypothetical FFC trades: A representative of Cephalopod, Inc., which wishes to hedge its risk by offering a fractional forward contract on its catch of squid, navigates to a website on a clearinghouse's, or exchange's server and enters information relating to the fractional forward contract Cephalopod wishes to offer. Specifically the representative indicates that the contract pertains to squid, that the unit is the pound, that the upper bound of Cephalopod's inventory, (in this case the capacity of their boat), is 50,000 pounds, and that Cephalopod is offering 50% of its catch, whatever it may be, during a contract period of Jan. 1, 2006 to Jan. 15, 2006, with a settling date of Jan. 17, 2006, and that Cephalopod is offering 50% of its catch at a price of $0.50 per pound. In one embodiment, Cephalopod would also specify the price to be paid to it for entering into the contract, such as $2500, which could be prorated for those wishing to accept the offer for less than the full fraction Cephalopod has offered. Cephalopod's offer is then entered into a database on a central clearinghouse server that displays the offer on the clearinghouse's website. A sample of the information that would be displayed is produced in FIG. 2. The first data row of the display corresponds to the above illustration. The second row lists the offering by a hypothetical tuna fishing boat operated by Fishing Inc.

A first buyer for Fishing, Inc., a squid processor navigates to the website on the clearinghouse's server, views Cephalopod's offer, and decides to accept 25% of Cephalopod's catch during the contract period, and agrees to pay $1250 for the contract. The clearinghouse's server updates the database and the website to reflect Fishing, Inc.'s purchase, and to show that the remaining 25% of Cephalopod's catch is still available.

A second buyer for Seafood Corp., another squid processor, repeats the process followed by the first buyer and decides to accept 15% of Cephalopod's catch during the contract period, and to pay $750 for the contract. The clearinghouse's server updates the database and the website to reflect Seafood Corp.'s purchase, and to show that the remaining 10% of Cephalopod's catch remains available for contract.

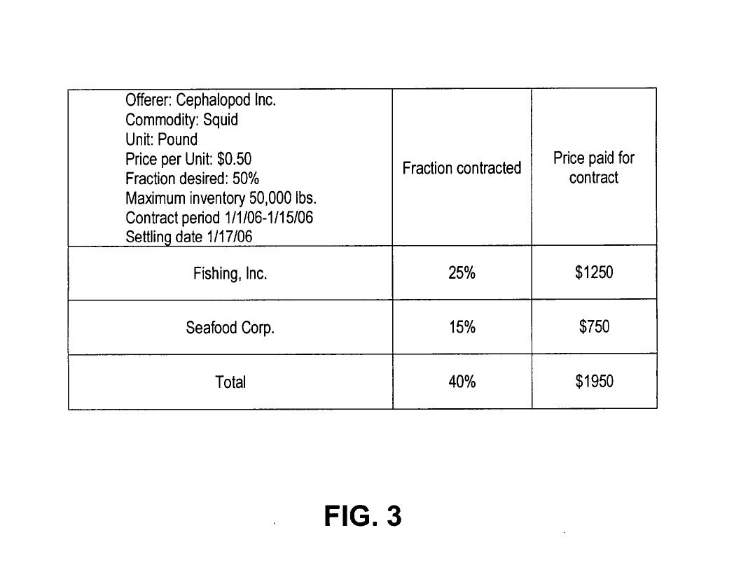

Cephalopod's boat puts to sea and returns on Jan. 16, 2006 with a catch of 30,000 lbs. of squid. On the following day, the settling date of Jan. 17, 2006, Fishing, Inc. buys 25% of the catch, or 7500 lbs., at a price of $0.50 per pound, for a total of $3750. Seafood Corp. buys its contracted 15% of Cephalopod's catch, or 4500 lbs., at the same price, for a total of $2250. Cephalopod, Inc. still owns the remaining 60% of the catch, or 18,000 lbs., comprising the unaccepted portion of the fractional forward contract (10%) and the 50% of uncontracted inventory, which may, for example, be sold on the spot market. FIG. 3 illustrates an exemplary database entry for the two FFCs described above following completion of the transaction.

Although the foregoing examples are directed to fish and seafood harvesting, those of skill in the art will recognize that fractional forward contracts have utility beyond commercial fishing, and indeed have utility in trading any commodity having a supply that is variable and unpredictable. For example, fractional forward contracts can be used by suppliers of computer parts, such as semiconductor manufacturers and distributors, by producers and distributors of petroleum products, such as oil and natural gas. Both of these examples are subject to fluctuations in market availability for reasons including production facility breakdown, weather-related or other natural disasters, labor interruptions, etc. A semiconductor distributor could offer a fractional forward contract for a portion of its inventory of semiconductor chips at some future time, such as a financial quarter in much the same fashion as described above for the fisherman, except that the unit would be the number of chips, rather than weight or volume. Similarly, a distributor of petroleum products could offer a fractional forward contract on oil, specifying his inventory in the number of barrels, for example, or on natural gas, where the unit might be cubic feet at a given pressure.

All patents, patent applications, and other publications cited herein are incorporated by reference in their entireties.

While the invention has been described in connection with one or more preferred embodiments, such embodiments are not intended to limit the scope of the invention to the particular form set forth, but, is intended to cover such alternatives, modifications, and equivalents as may be included within the spirit and scope of the invention as defined in the appended claims.

1. A method for managing a market for trading of a commodity having an inventory that is variable and unpredictable at a future date, the method comprising:
creating a plurality of fractional forward contracts for transferring one or more portions of the inventory from a first party to at least one second party at a per portion price at a specified future date, wherein the one or more portions comprises a specified fraction of the inventory that is available to the first party over a pre-determined period of time at the future date; and
providing a trading exchange for trading the plurality of fractional forward contracts.

2. The method of claim 1, further comprising:
maintaining within the trading exchange records comprising the available inventory of one or more first parties and fractional forward contracts entered between the one or more first parties and the at least one second party.

3. The method of claim 2, wherein the trading exchange further generates reports to the one or more first parties and the at least one second party comprising terms of the fractional forward contracts entered between the parties.

4. The method of claim 1, further comprising:
defining a plurality of transferable quotas, each comprising a fraction of a total available inventory from a specified source;
assigning one or more transferable quotas to one or more first parties and dividing each transferable quota into a plurality of equal fractions, wherein each fractional forward contract is for one or more equal fractions.

5. The method of claim 4, wherein the total available inventory is specified by a regulatory agency and wherein the trading exchange further receives the specified total available inventory and allocates the transferable quotas for assignment to the one or more first parties.

6. The method of claim 4, wherein the trading exchange further provides for exchanging transferable quotas between a plurality of first parties.

7. The method of claim 1, wherein the commodity is fish or seafood and the one or more first parties harvest the fish or seafood from the ocean.

8. The method of claim 1, wherein the commodity is fish or seafood and the one or more second parties are fish/seafood processors.

9. The method of claim 7, wherein the fish or seafood is squid.

10. The method of claim 1, wherein the commodity is manufactured goods.

11. The method of claim 1, wherein the commodity is a petroleum product.

12. The method of claim 1, wherein at least one of the first party and the at least one second party is a speculator.

13. The method of claim 1, wherein the first party and the at least one second party communicate with the trading exchange by way of a computer network.

14. A method for exchanging assets having unpredictable and variable availability, comprising:
creating a trading exchange for the assets, wherein the trading exchange is operable for:
defining a plurality of transferable units, each comprising a fraction of a total available inventory of the asset from a specified source;
assigning one or more transferable units to one or more sellers and dividing each transferable unit into a plurality of equal fractions;
creating a plurality of fractional forward contracts for transferring one or more equal fractions from the one or more sellers to at least one buyer at a pre-determined date, wherein each equal fraction comprises a percentage of the asset within the transferable unit over a pre-determined period of time; and
recording fractional forward contracts entered into between the one or more sellers and the at least one buyer.

15. The method of claim 14, wherein the trading exchange is further operable for exchanging transferable units between a plurality of sellers.

16. The method of claim 14, wherein the asset is fish or seafood.

17. The method of claim 16, wherein the fish or seafood is processed.

18. The method of claim 14, wherein the asset is manufactured goods.

19. A system for trading a commodity having an inventory that is variable and unpredictable at a future date, the system comprising:
a trading exchange server connected to a computer network and a database for storing a plurality of fractional forward contract offers and transactions;
at least one first user interface connected to the network for submitting to the trading exchange server terms of one or more fractional forward contract offers for selling one or more fractions of the inventory that is available to a first party over a specified period at a specified future date at a specified price per unit of the available inventory;
at least one a second user interface connected to the network for viewing and communicating acceptance of terms of the offers for purchase of a selected fraction of the available inventory by at least one second party;
wherein the trading exchange server records the terms and the acceptance by the at least one second party for storage in the database, and after the specified future date has passed, records a total price paid by the at least one second party for the selected fraction of the available inventory.

20. The system of claim 19, wherein a total available inventory is specified by a regulatory agency and wherein the trading exchange server further receives the specified total available inventory from the regulatory agency and allocates the transferable quotas for assignment to the one or more first parties.

21. The system of claim 20, wherein the trading exchange further operates to permit trading of the allocated transferable quotes between a plurality of first parties.

22. The method of claim 8, wherein the fish or seafood is squid.
